(19) United States
(12) Patent Application Publication
(10) Pub. No.: US 2020/0143386 A1
(43) Pub. Date: May 7, 2020

(54) ARTIFICIAL INTELLIGENCE BASED CUSTOMER SERVICE ASSESSMENT

(71) Applicant: Electronic Arts, Inc., Redwood City, CA (US)

(72) Inventor: Matthew Douglas Tomlinson, Cedar Park, TX (US)

(21) Appl. No.: 16/182,065

(22) Filed: Nov. 6, 2018

(51) Int. Cl. G06Q 30/00; G06N 3/08; H04L 12/58

(52) U.S. Cl. CPC G06Q 30/016; H04L 51/02; G06N 3/08

(57) ABSTRACT

A support assessment system and method generate metrics to assess the quality, effectiveness, process adherence, or the like of customer support interactions. These metrics may be generated based at least in part on one or more support assessment models to provide objective measures of the customer support interactions. The support assessment models may be trained on training data based on a set of support conversations and indication of the metrics that are to result from those support conversations. The support assessment models may be any variety of machine learning models, such as neural network models. The objective measures generated by the support assessment models may further be used to recommend process changes, add or discontinue products or services, make assessments of customer support resources, and/or generate customer support training materials.

### BACKGROUND

Customer support, such as chat-based or voice-based customer support, as provided by either a human or an automated agent (e.g., artificial intelligence bot), may have various levels of quality and effectiveness. The quality levels, effectiveness levels, and/or other assessments of such customer support interactions are typically spot checked by humans (e.g., customer service managers). These assessments are typically highly-subjective and may be performed on an inadequate sample size to quickly identify systemic and/or process problems. Additionally, it may be difficult to consider an aggregation of customer support assessments to effectively make process, training, and/or personnel changes.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an example environment including a support assessment system to assess one or more support assessment outcomes from customer service interactions, in accordance with example embodiments of the disclosure.

FIG. 2 illustrates an example environment where the support assessment system of FIG. 1 uses training data to generate support assessment models, in accordance with example embodiments of the disclosure.

FIG. 3 illustrates a flow diagram of an example method for determining support assessment outputs, in accordance with example embodiments of the disclosure.

FIG. 4 illustrates a flow diagram of an example method for determining process changes, changes to services or products, and/or the effectiveness of customer service resources, in accordance with example embodiments of the disclosure.

FIG. 5 illustrates a flow diagram of an example method to generate one or more support assessment models, in accordance with example embodiments of the disclosure.

FIG. 6 illustrates a flow diagram of an example mechanism for generating support assessment scores and next steps associated with a customer service conversation, in accordance with example embodiments of the disclosure.

FIG. 7 illustrates a block diagram of example support assessment system(s) that may provide predictive model generation services, in accordance with example embodiments of the disclosure.

### DETAILED DESCRIPTION

Example embodiments of this disclosure describe methods, apparatuses, computer-readable media, and systems for determining one or more metrics associated with a customer service interaction, as well as proposed changes associated with an aggregate of customer service interactions. The metrics may indicate the performance of various elements of a customer service interaction, such as a quality score related to the interaction with the customer, a process score related to adherence to a process for addressing the customer's needs, an effectiveness score related to outcomes associated with the interaction, or the like. The interactions and/or the metrics generated therefrom may also be analyzed to determine any process changes and/or next steps associated with various types of customer interactions. Additionally, the customer interactions may provide an indication of relative levels of help topics requested by customers. The metrics may also be used to evaluate customer service resources (e.g., customer service agents, automated customer service agent (bot), etc.) and/or provide training resources.

A customer service interaction, in the form of a support conversation, as provided by a human or an artificial intelligence (AI) agent and/or bot, may be recorded. The customer service interaction may be via any suitable mechanism, such as a chat session, voice interaction, text interaction, telephone call, voice over Internet protocol (VoIP), or the like. The support conversation may be supported and/or enabled by one or more support platform system(s) that enable the interaction between a user or customer and a customer service center with a human or AI agent. The support conversation, in some cases, may be stored in a conversation datastore to be accessed by one or more conversation processing system(s). The conversation processing system(s) may be configured to generate one or more conversation parameter value(s) and/or conversation parameter data.

The conversation parameter data may include any variety of suitable information and/or meta-representations of the support conversation or portions thereof. The customer service interaction, and the support conversation resulting therefrom, if in the form of a voice interaction, may be provided to an automated speech recognition (ASR) system to perform a voice-to-text conversion of the customer service interaction for further processing. Thus, in some cases, the conversation parameter data may include textual transcripts of an audio conversation, if the support conversation was in an audio and/or voice exchange. If the customer service interaction is in the form of a text interaction (e.g., chat help), then the text from the interaction may be organized for further processing. In either audio and/or textual service conversations, a textual representation, with or without an audio representation, may be provided and used for generating conversation parameter data.

With a text representation of the support conversation, the text may be provided to a natural language understanding (NLU) processor (e.g., natural language processor (NLP)) to generate a natural language interpretation of the recorded customer service interaction. The NLU data may provide understanding of the service conversation considering not just syntax and lexicon, but also ontology, semantics, context and any other suitable factors associated with conversations. The NLU data may also be included in the conversation parameter data of the support conversation.

Clustering analysis may also be performed on the support conversation using any number of suitable clustering algorithms, such as k-means clustering, distribution clustering, or the like. This cluster analysis may produce cluster data that may be part of the conversation parameter data. Other conversation parameter data may include any variety of annotations to the support conversation and/or any other suitable conversation parameter data.

The conversation parameter data of the support conversation may be received by one or more support assessment system(s) and applied to one or more support assessment model(s) to generate support assessment output(s). The support assessment output(s) may include one or more metrics that provide an indication of quality of one or more aspects of the support conversation. One such metric may be a conversation quality score that indicates the quality and flow of the conversation. This conversation quality score may indicate if the human or automated agent was friendly, helpful, relevant, or the like. The conversation quality score may be on any suitable scale, such as 0-100, 0-1, or the like. The conversation quality score may be generated using a conversation quality model.

According to additional example embodiments, the support assessment system(s) may further receive one or more processes descriptions, such as a process flow or standard operating procedures (SOP) for a particular support service (e.g., renew account, reset password, pay bill, etc.). The support assessment system(s) may use the conversation parameter data and the one or more process descriptions to generate a process score. This process score may indicate adherence to a particular process related to the support call. For example, if a customer wishes to renew his/her account, the human or automated agent may conduct a support conversation with the customer. The agent may be prescribed a process flow to address account renewals. A strong adherence to the recommended process flow may result in a good (e.g., high) process score. Poor adherence to the prescribed process flow may result in a poor (e.g., low) process score.

In additional example embodiments, the support assessment system(s) may further be provided with one or more outcome(s) of the support conversation. These outcome(s) may be received from any variety of systems associated with customer. For example, in a situation where the customer wishes to reset his or her account password, an outcome associated with that user may be received from a service providing system, such as an online gaming system, that indicates that the customer has successfully reset his or her password. The indication of this outcome may be received from the service providing system by the support assessment system(s). The support assessment system(s) may be able to determine an effectiveness score based at least in part on the outcome. In some cases, the outcome may not be a binary outcome, as in the previous example. For example, an outcome may indicate an amount of time that a customer, such as an online gamer, plays a certain online video game.

In some example embodiments, the effectiveness score may not be generated at the same time as the conversation quality score and/or the process score. The outcomes associated with a particular support conversation may take some time to be resolved and/or measured. In other words, while the data to determine the conversation quality score and/or process score may be available relatively quickly, all of the data to determine the effectiveness score may not be available relatively quickly after a support conversation takes place. In some cases, a subset of the support assessment outputs (e.g., the conversation quality score and the process score) may be available relatively soon after the conclusion of the corresponding support conversation, and other support assessment outputs (e.g., effectiveness score and the overall score) may not be available until a later time. As a non-limiting example, the conversation quality score for a support conversation may be available within 30 seconds after the support conversation, while the effectiveness score may be available the day after the support conversation. In some further examples, the post-contact engagement measures of outcomes needed to generate the effectiveness scores may not be available for 30 or more days after the support conversation.

In some cases, estimates of the effectiveness score may be provided and may be updated as more information about outcomes associated with a support conversation is provided to the support assessment system(s). For example, if some outcome data corresponding to a support conversation are available at a particular point in time after the support conversation, and initial effectiveness score may be determined. If after that particular point in time, additional outcome data associated with the support conversation are made available, then the initial effectiveness score may be updated to reflect the additional outcome data available. As a non-limiting example, a preliminary effectiveness score may be generated one minute after the support conversation, along with the conversation quality score and the process score, and after two days, a final effectiveness score may be generated with additional outcome data made available since the initial effectiveness score was determined.

The support assessment system(s) may further be configured to determine an aggregate score or overall score that incorporates, such as by a suitable mathematical combination (e.g., sum, average, weighted average, median, etc.), the conversation quality score, the process score, and/or the effectiveness score. In some embodiments, there may be additional scores and/or metrics than the ones discussed herein that may be incorporated into the overall score. This overall score may provide an indication of the overall quality of the support conversation, including the conversation quality, the process, and/or the effectiveness. In the cases, where one or more of the support assessment scores update with time, such as in the case where the effectiveness score updates with the availability of incremental outcome data, the overall score may also update according to the other support assessment scores. These scores may provide an objective and relatively repeatable assessment of customer service conversations.

Additionally, these scores may be determined to all or nearly all customer support conversations of a customer service center or organization, rather than more traditional mechanisms of humans spot checking a relatively small subset of support conversations.

The support assessment scores may be generated based at least in part on one or more support assessment models. These support assessment models may be of any suitable type, such as any variety of machine learning and/or artificial intelligence models, such as neural network models. Neural network models may be implemented if the assessment scores to be modeled are relatively difficult or are a relatively non-linear problem. The inputs to the support assessment models may be the conversation parameter data, outcomes, and/or indications of prescribed process flow. Other machine learning model(s) that may be generated and used may include, for example, linear regression models, decision tree models, random forest models, Bayesian network models, any variety of heuristics (e.g., genetic algorithms, swarm algorithms, etc.), combinations thereof, or the like. The logistic regression models may be relatively lightweight models that may be relatively easy to understand and relatively computationally light to implement during deployment compared to machine learning models. In example embodiments, the support assessment models may be a combination of different machine learning models.

The support assessment scores may be used to make determine one or more additional elements associated with individual support conversations and/or a group of support conversations. In some example embodiments, the support assessment scores may be used to identify particularly bad (e.g., low conversation quality score, effectiveness score, process score, and/or overall score). In these cases, a follow up customer support interaction may be scheduled to attempt to fix any infirmities in the initial support conversation. Additionally, the support resources (e.g., human or bot agents) may be evaluated based on the support assessment scores. Further still, support conversations that result in particularly bad support assessment scores may be used in training support resources. These particularly bad support conversations may be studied and/or used to train customer support resources on what not to do during support conversations.

In example embodiments, discrepancies between the process score of a support conversation and an effectiveness score of the support conversation may prompt a recommendation that process flow changes be implemented. For example, if a particular support conversation results in a good (e.g., high) effectiveness score, but a bad (e.g., low) process score, then that support conversation may result in poor adherence to a prescribed process, but still resulted in a good outcome from the support conversation. Conversely, if a particular support conversation results in a bad (e.g., low) effectiveness score, but a good (e.g., high) process score, then that support conversation may result in good adherence to a prescribed process, but still resulted in a bad outcome from the support conversation. In these cases, the prescribed process flow may be reviewed to determine if possible improvements can be made to the prescribed process flow, such that a revised prescribed process flow may be more aligned with the effectiveness of the support conversation. In some example embodiments, an aggregate of support conversations associated with a prescribed process flow, and their corresponding effectiveness scores and process scores may be considered in determining if a process flow change is to be implemented.

In some example embodiments, an aggregate of support conversations, and their corresponding support assessment scores, may be used to identify training materials, such as example good and/or bad example support conversations that may be used to for training agents. For example, a 10/80/10 mechanism may be used where the top ten percent of support conversations may be identified for use in training agents on good support conversation techniques to use, and the bottom ten percent of support conversations may be identified to for use in training agents on bad support conversation techniques to avoid. The 10 percent levels are merely an example, and any other suitable percentile threshold may be used to identify good and bad example support conversations, based at least in part on one or more of the support assessment scores, for the purposes of training.

In further example embodiments, an aggregate of support conversations, and their corresponding support assessment scores, may be used to identify high performing customer support resources (e.g., human agents and/or automated agents) and poorly performing customer service resources. For example, the poorly performing customer support resources may be identified as having low average support assessment scores for the support conversations that they handle. In some cases, a low average assessment score (e.g., overall score, effectiveness score, process score, conversation quality score, etc.) may be identified by comparing the score to a corresponding threshold level. In other cases, the agents at or below a predetermined percentile threshold (e.g., lowest 5 percentile, lowest 10 percentile, etc.) of scores may be identified as poorly performing customer support resources. These customer support resources may be targeted for corrective actions, such as additional training for human agents or algorithmic changes to automated agents. High performing customer support resources may also be identified by similar mechanisms. The high performing resources may be rewarded, promoted, or engaged in training other customer service resources.

In further example embodiments, problematic products or services may be identified from an aggregate of support conversations and their corresponding support assessment scores. If a particular product or service spawns high level of customer support, or if the customer support offered does not seem to be effective, as measured by the support assessment scores, then further actions may be taken on those products or services. For example, a reengineering or tweak to the product or service may be made. Alternatively, the product or service may be discontinued, halted, and/or temporarily suspended. In similar example embodiments, if there is a recent rise in the customer support and/or a recent decrease in the support assessment scores associated with a particular product or service, then that product or service may be identified for potential further actions.

An example of a customer support scenario, according to the embodiments discussed herein, may include a user or customer who is an online gamer and wishes to purchase access to a new online video game. The customer may wish to be assisted in making the purchase of the access to the online video game by a service agent during a support conversation. The customer may make a request, and by a series of interactions with the support agent, gain access to the desired online video game. In this case, the support conversation may be recorded, and conversation parameter data may be generated for the support conversation. This conversation parameter data may be applied to a conversation quality model to generate a conversation quality score. Additionally, a prescribed process flow for selling access to the desired online video game may be identified. This prescribed process flow may be identified from a collection of prescribed process flows. Adherence to the prescribed process flow may be determined using the conversation parameter data applied to a process model to indicate a process score. Further still, an indication of whether the customer was able to actually access the desired online video game may be received and applied to an effectiveness model to determine an effectiveness score. Thus, objective metrics to measure the conversation quality, the effectiveness, and the process adherence may be provided for the support conversation. In some cases, the conversation quality score, process score, and/or the effectiveness score may be combined into an overall score.

Continuing with the example of the customer desiring access to the new online video game, once the conversation quality score, the process score, and the effectiveness score are generated by employing corresponding respective models, additional elements may be determined and/or performed. If an unusually low score for any one of the conversation quality score, effectiveness score, process score, and/or overall score, then the agent associated with the support conversation may be identified for additional training or other corrective measures. Low scores, in example embodiments, may be identified by comparing to corresponding threshold levels. Low scores, may also prompt a follow up interaction with the customer to make sure that the customer's needs are correctly resolved. In some cases, if one or more of the scores are particularly high, then the agent may be identified and/or rewarded. If the scores indicate a discrepancy between the effectiveness score and the process score, then a recommendation may be made to change the prescribed process sequence.

Although an example in the realm of video games and online gaming is discussed above, it should be understood that the customer support mechanisms, as described herein, may be applied to any variety of customer support situations. Indeed, without providing an exhaustive list of applications, the support assessment models, as generated and deployed, may be applied to any suitable type of customer service interaction. For example, support conversations may originate in a variety of industries, such as online gaming, retail, sales, education, scientific endeavors, publishing, real estate, information services, online services, or any other suitable industry. For example, a customer support conversation in the realm of helping a cable internet customer set up internet service in his or her home may be subject to the mechanisms as discussed herein.

As discussed above, the support assessment models may be any suitable model, such as any variety of machine learning and/or artificial intelligence models, like neural network models. Other machine learning model(s) that may be generated and used may include, for example, linear regression models, decision tree models, random forest models, Bayesian network models, any variety of heuristics (e.g., genetic algorithms, swarm algorithms, etc.), combinations thereof, or the like. These support assessment models may be trained using training data that may include training support conversations, along with corresponding training conversation parameter data, training outcomes, and/or training prescribed process flows. Additionally, scores corresponding to each of the support conversations, such as the conversation quality score, the effectiveness score, and/or the process score may be included in the training data. The training data may then be used to train models that have the support conversations, the conversation parameter data, and/or the prescribed process flows as inputs, and the support assessment scores as outputs. This training may be supervised, unsupervised, or partially supervised (e.g., semi-supervised). This training may include training to key phrases (e.g., n-grams), as received in the training conversation parameter data, other NLU parameters, cluster analysis parameters, or the like.

It should be understood that the systems and methods, as discussed herein, are technological improvements in the field of customer service and online interactions. For example, the methods and systems as disclosed herein enables computing resources to improve support conversations, processes used to service customers, and/or resources used to support customers. These improvements manifest in automation, efficiencies, thoroughness, speed, objectivity, and repeatability over traditional mechanisms of evaluating support calls by tedious human-based spot-checking of support conversations. Indeed, the disclosure herein provides improvements in the functioning of computers to provide improvements in the technical field of support conversations and downstream actions and process improvements.

Machine learning and artificial intelligence (AI)-based processes are disclosed that can provide assessment of all, or nearly all support conversations that an organization may conduct. This type of extensive evaluation of support conversations are not possible with traditional manual mechanisms. Furthermore, the mechanisms and systems discussed herein, provide objective and repeatable evaluations of support conversations, which is not possible using traditional mechanism of support evaluation. Additionally, the technological problems addressed here are ones that arise in the computer-era, such as in the fields of online customer service. Thus, not only is the disclosure directed to improvements in computing technology, but also to a variety of other technical fields related to support services. The mechanisms, as described herein, cannot be replicated by traditional mechanisms or in the mind with paper and pencil, as such traditional mechanism cannot assess the support conversations consistently, thoroughly, or completely. The trained assessment models, as described herein, provide consistent, objective assessments that can be performed on a complete set of support conversations.

Certain implementations and embodiments of the disclosure will now be described more fully below with reference to the accompanying figures, in which various aspects are shown. However, the various aspects may be implemented in many different forms and should not be construed as limited to the implementations set forth herein. It will be appreciated that the disclosure encompasses variations of the embodiments, as described herein. Like numbers refer to like elements throughout.

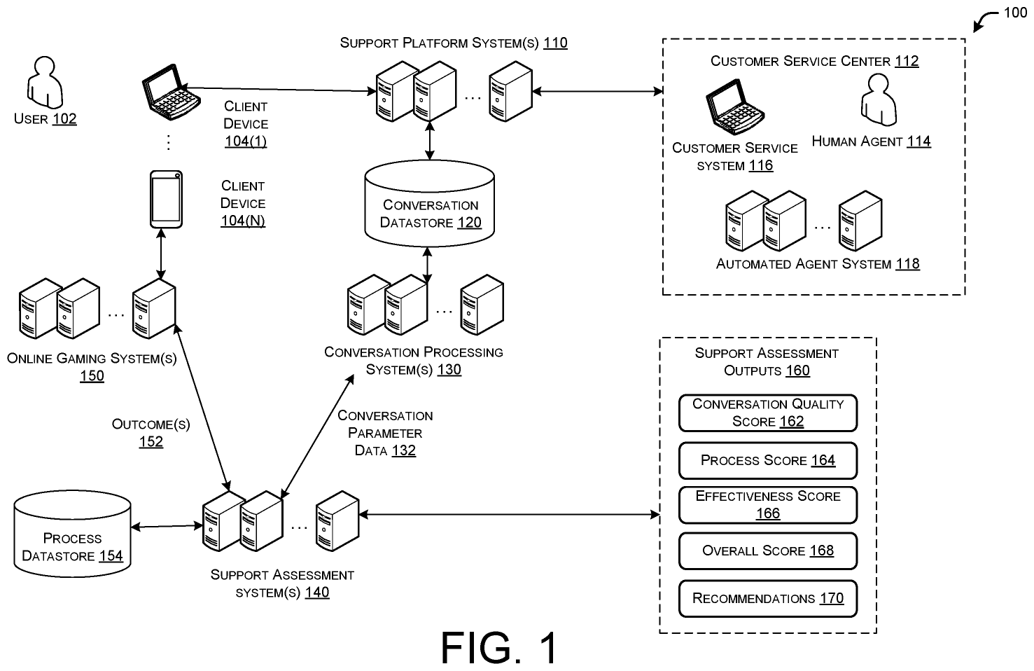

FIG. 1 illustrates an example environment 100 including a support assessment system 140 to assess one or more support assessment outputs 160 from customer service interactions, in accordance with example embodiments of the disclosure.

The environment 100 may include a user or customer 102 who may be able to access one or more support platform system(s) 110 via one or more client devices 104(1) . . . 104(N), hereinafter referred to as client device 104 or client devices 104. The customer 102 may be any suitable user of products or services, such as online gaming, online retail, or the like.

The client device 104 may be any suitable device, including, but not limited to, a netbook computer, a notebook computer, a desktop computer system, a set-top box system, a handheld system, a smartphone, a telephone, a personal digital assistant, a wearable computing device, a smartwatch, a Sony Playstation® line of systems, a Nintendo Wii® line of systems, a Microsoft Xbox® line of systems, any gaming device manufactured by Sony, Microsoft, Nintendo, or Sega, an Intel-Architecture (IA)® based system, an Apple Macintosh® system combinations thereof, or the like. In general, the client device 104 may be configured to enable the customer 102 to conduct a support conversation via the support platform system(s) 110.

The environment may further include a customer service center 112, which may include any number of agents, such as a human agent 114 who may interface with the support platform system(s) 110 via a customer service system 116 and/or an automated agent system 118. The agents 114, 118 may be able to conduct a customer service interaction as a support conversation from the customer service center 112, via the support platform system(s) 110, with the customer 102 via his or her client device 104.

The support platform system(s) 110 may enable support conversations between the customer 102 and the customer service center 112. The support conversation may be via any suitable mechanism, such as a chat session, voice interaction, text interaction, telephone call, voice over Internet protocol (VoIP), or the like. The support platform system(s) 110 may provide application program interfaces (APIs) to interface with, and enable, a wide variety of communications modes between the customer's client device 104 and the customer service center 112. A support conversation, as used herein may refer to any suitable type of communications, including voice, text, video, or the like. A support conversation, as provided by a human agent 114 or an automated agent system 118, may be recorded as a text transcript, video recording, and/or audio recording. The recorded support conversation may be stored in a conversation datastore 120 that may be accessed by one or more other entities of the environment 100, such as one or more conversation processing system(s) 130.

The one or more conversation processing system(s) 130 may be configured to receive stored and/or recorded support conversations, such as from the conversation datastore 120. The conversation processing system(s) 130 may be configured to generate conversation parameter data 132 corresponding to a support conversation. The conversation parameter data 132 may result from a variety of analysis of the corresponding support conversation. This analysis may include ASR, NLU, clustering or the like. The conversation parameter data 132 may include, for example, k-means clustering data, n-grams, key phrases, parts-of-speech tagging, segmentation data, lexical semantics data, contextual semantics data, sentiment analysis data, discourse analysis data, combinations thereof, or the like. In the same or some alternative embodiments, the conversation parameter data 132 may include vector-based language understanding data. It should be understood that the aforementioned elements of the conversation parameter data are just examples, and that the conversation parameter data 132 may include any suitable analysis, fragmentation, metadata, and/or descriptions of the underlying support conversation.

The conversation parameter data 132 may be received by one or more support assessment system(s) 140. In some alternate embodiments, the functions of the support assessment system(s) 140 and the conversation processing system(s) 130 may be combined into a single system. The support assessment system(s) 140 may be configured to receive one or more outcome(s) 152 from one or more other systems, such as one or more online gaming system(s) 150. The support assessment system(s) 140 may still further be configured to receive prescribed process flow information from a process datastore 154.

The online gaming system(s) 150 may provide the customer 102 with access to a product or service, such as an online video game. In this case, the customer 102 may engage with the customer service center 112 pertaining to his or her product or service related to the online gaming, as provided by the online gaming system(s) 150. In some cases, the customer 102 may interact with the online gaming system(s) 150 with the same client device 104 with which he or she engages with the support platform system(s) 110 to interact with the customer service center 112. In other cases, the customer 102 may use a different client device 104 to interact with the online gaming system(s) 150 from which client device 104 he or she uses to interact with the support platform system(s) 110. It should be understood that in some cases, the support platform system(s) 110 may be integrated with the online gaming system(s) 150 as a single system with the functionality of both systems 110, 150, as described herein.

The online gaming system(s) 150 may be configured to provide a variety of outcome(s) 152 to the support assessment system(s) 140. For example, the online gaming system(s) 150 may indicate if the customer 102 has logged into his or her account on the online gaming system(s) 150, how long the customer 102 spent engaged with the online gaming system(s) 150, if or how much the customer 102 spent on in-game purchases, which online video games the customer 102 is playing, the customer's performance on various online video games, etc. Indeed, there are any variety of outcome(s) 152 that can be generated by the online gaming system(s) 150 that maybe provided to the support assessment system(s) 140.

It should further be understood that the online gaming system(s) 150 are an example of a system that can provide products and/or services to the customer 102 for which the customer 102 may engage support interactions with the customer service center 112. Indeed, there may be any variety of other system(s) that can provide relevant outcomes 152 that may be used by the support assessment system(s) to determine effectiveness of a support conversation between the customer 102 and the customer service center 112. For example, alternative systems may include an online retail system that can provide outcomes such as login frequency of the customer 102, product or service interests of the customer 102, the amount spent by the customer 102, etc. Other systems may include systems/hubs for access to broadband/network services, telecommunications systems, educational institution systems, online publishing systems, inventory tracking systems, financial institution systems, etc.

The support assessment system(s) 140 may be configured to use the conversation parameter data 132, the outcomes 152, and/or the prescribed process flows to generate support assessment outputs 160 corresponding to the support conversation between the customer 102 and the customer service center 112. These support assessment outputs 160 may include a conversation quality score 162, a process score 164, effectiveness score 166, and/or overall score 168. In some cases, one or more recommendations 170 may also be generated by the support assessment system(s) 140.

The support assessment system(s) 140 may have one or more models, such as machine learning models to generate each of the support assessment outputs 160. In example embodiments, the conversation quality score 162 may be generated by applying the conversation parameter data to a conversation quality model. The conversation quality score 162 for a support conversation may indicate how well the conversation was conducted, whether the conversation was relevant to the customer's needs, whether the agent 114, 118 was appropriately responsive, whether the conversation had a friendly, non-confrontational tone, whether the conversation had an appropriate speed and/or progression rate, whether the speaking speed or response wait time was appropriate, whether the customer sounded satisfied, etc.

In example embodiments, the process score 164 may be generated by the support assessment system(s) 140 using the conversation parameter data 132 to determine a category of support (e.g., password reset, purchase new service, etc.) and access the corresponding prescribed process flow from the process datastore 154. The conversation parameter data 132, as well as the prescribed process flow data may be applied to a process model to determine the process score 164. The process score 164 may be indicative of how closely the agent 114, 118 adhered to the prescribed process flow.

According to example embodiments of the disclosure, the effectiveness score 166 may be generated by the support assessment system(s) 140 using the outcomes 152 corresponding to the support conversation. This correspondence may be determined by matching the customer 102 associated with the outcomes 152 to the same customer 102 that engaged in a particular support conversation. The outcomes 152, as well as the conversation parameter data 132, may be applied to an effectiveness model to generate the effectiveness score 166. The effectiveness score 166 may be indicative of how effective the support conversation was in resolving the customer's needs.

The conversation quality score 162, the process score 164, and/or the effectiveness score 166 may be on any suitable scale, such a as 0-1, 1-100, etc. In some cases, the conversation quality score 162, the process score 164, and/or the effectiveness score 166 may be on the same scale, and in other cases, they each have their own ranges of values. The overall score 168 may be generated by the support assessment system(s) 140 based at least in part on the conversation quality score 162, the process score 164, and/or the effectiveness score 166. The overall score may be any suitable mathematical combination of the conversation quality score 162, process score 164, and/or the effectiveness score 166. For example, the overall score 168 may be a sum, average weighted average, median or any other suitable function of the conversation quality score 162, process score 164, and/or the effectiveness score 166.

The recommendations 170 may be generated by the support assessment system(s) 140 based at least in part on the support assessment outputs 160. For example, particularly bad (e.g., low) support assessment scores 160 of a support conversation may trigger a potential indication of issues with the corresponding agent 114, 118. Similarly, particularly good (e.g., high) support assessment scores 160 of a support conversation may trigger a potential recommendation of rewarding the agent 114 or making an example of the support conversation to other agents 114 and/or modifying the algorithms of the automated agent system 118 based in part on the support conversation. Additionally, inconsistencies between the support assessment scores 160 may trigger other recommendations, such as potentially changing a prescribed process flow for a particular category of support.

In example embodiments, aggregates of the support assessment scores 160 may be used to make recommendations. For example, if a particular product or service has a high level (e.g., total number or as a percentage) of support conversations or if support conversations of that product or service provides poor results, as measured by the support assessment scores 160, then a recommendation may be made to discontinue and/or modify that product or service. Aggregated support assessment scores 160 of a particular agent 114, 118 may be used to make recommendations on the performance, rewards, and/or training needs of agents 114, 118. In some cases, the recommendations for process changes, as described above, may be made based on an aggregate of support assessment scores 160 pertaining to a particular prescribed process flow.

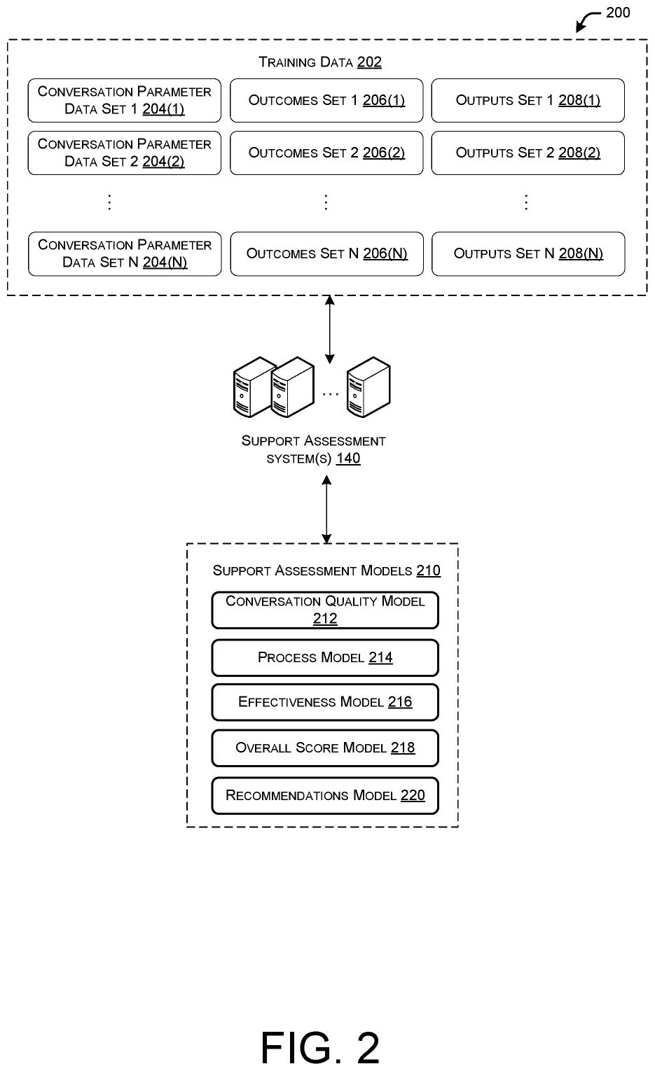

FIG. 2 illustrates an example environment 200 where the support assessment system(s) 140 of FIG. 1 uses training data 202 to generate support assessment models 210, in accordance with example embodiments of the disclosure. The support assessment system(s) 140 may be configured to generate support assessment models 210 used to generate the support assessment outputs 160. To generate support assessment models, the various models may be trained using training data 202 as received by the support assessment system(s) 140.

The trained support assessment models 210 may be any suitable model, such as any variety of machine learning and/or artificial intelligence models, like neural network models. Other machine learning model(s) 210 that may be generated and used may include, for example, linear regression models, decision tree models, random forest models, Bayesian network models, any variety of heuristics (e.g., genetic algorithms, swarm algorithms, etc.), combinations thereof, or the like.

These support assessment models 210 may be trained using the training data 202 that may include conversation parameter data sets 204(1), 204(2), . . . , 204(N), hereinafter referred to conversation parameter data set 204 or conversation parameter data sets 204. The training data 202 may further include outcomes sets 206(1), 206(2), . . . , 206(N), hereinafter referred to outcome set 206 or outcome sets 206. The training data 202 may still further include output sets 208(1), 208(2), . . . , 208(N), hereinafter referred to output set 208 or output sets 208. The output sets 208 may include support assessment outputs 160 as previously determined for the training support conversations and may correspond respectively to the conversation parameter data sets 204 and/or the outcome sets 206. The support assessment outputs may include a conversation quality score, a process score, and effectiveness score, and/or an overall score for each output set 208 corresponding to respective outcomes set 206 and conversation parameter data set 204. The outputs set 208 for training may be determined by a human or other models or assessment engines.

The conversation parameter data sets 204 may be conversation parameter data 132 for corresponding training support conversation. The conversation parameter data sets 204 may result from a variety of analysis of the corresponding training support conversation. This analysis may include ASR, NLU, clustering or the like. The conversation parameter data sets 204 may include, for example, k-means clustering data, n-grams, key phrases, parts-of-speech tagging, segmentation data, lexical semantics data, contextual semantics data, sentiment analysis data, discourse analysis data, combinations thereof, or the like. In the same or some alternative embodiments, the conversation parameter data sets 204 may include vector-based language understanding data. It should be understood that the aforementioned elements of the conversation parameter data are just examples, and that the conversation parameter data sets 204 may include any suitable analysis, fragmentation, metadata, and/or descriptions of the underlying support conversation.

The outcomes sets 206 may be outcomes 152 corresponding to conversations that have been assessed and may correspond respectively to the conversation parameter data sets 204. These outcome sets 206 may indicate, for example, login success, account access success, account renewal success, dollars spent by customer 102, time spent online by customer 102, services accessed by customer 102, or any other indicators of success or effectiveness of a support conversation.

With the training data 202, a conversation quality model 212, process model 214, and/or an effectiveness model 216 may be trained. This training may be supervised, unsupervised, or partially supervised (e.g., semi-supervised). This training may include fitting the provided output sets 208 of the training data 202 to the inputs of the conversation parameter data sets 204 and/or the outcomes sets 206.

An overall score model 218 may be generated as a mathematical combination of the conversation quality model 212, the process model 214, and/or the effectiveness model 216. In some cases, the overall score model 218 may be an average of the outputs of the conversation quality model 212, the process model 214, and/or the effectiveness model 216. However, any suitable combination of the conversation quality model 212, the process model 214, and/or the effectiveness model 216 may be implemented for the overall score model 218.

A recommendations model 220 may be generated as a collection of rules that suggest potential actions based at least in part on the support assessment scores 160, as generated by the conversation quality model 212, the process model 214, and/or the effectiveness model 216. For example, score thresholding may be used to identify particularly low support assessment scores 160 that may prompt a recommendation of corrective actions and/or particularly high support assessment scores 160 that may prompt a recommendation for rewarding the corresponding agent 114 and/or training based on the agent 114, 118. Other analysis may involve identifying discrepancies between support assessment scores to identify any process changes to recommend and/or products or services to discontinue or modify.

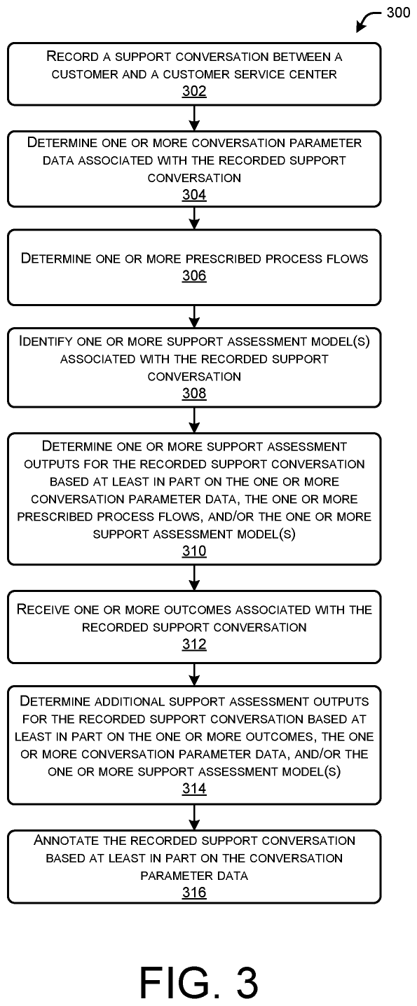

FIG. 3 illustrates a flow diagram of an example method for determining support assessment outputs, in accordance with example embodiments of the disclosure. In example embodiments, the method 300 may be performed by the support assessment system(s) 140. In some example embodiments, the method 300 may be performed in conjunction with one or more other entities of the environment 100, such as the conversation processing system(s) 130, the support platform system(s) 110, and/or the online gaming system(s) 140.

At block 302, a support conversation between a customer and a customer service center may be recorded. As described herein, this may be performed by the support platform system(s) 110, in example embodiments. The recording may be a textual recording, an audio recording, and/or a video recording of the support conversation. In some cases, the recording may be stored in the conversation datastore 120.

At block 304, one or more conversation parameter data associated with the recorded support conversation may be determined. The conversation parameter data 132 may result from a variety of analysis of the support conversation. This analysis may include ASR, NLU, clustering or the like. The conversation parameter data 132 may include, for example, k-means clustering data, n-grams, key phrases, parts-of-speech tagging, segmentation data, lexical semantics data, contextual semantics data, sentiment analysis data, discourse analysis data, combinations thereof, or the like. In the same or some alternative embodiments, the conversation parameter data 132 may include vector-based language understanding data. It should be understood that the aforementioned elements of the conversation parameter data are just examples, and that the conversation parameter data 132 may include any suitable analysis, fragmentation, metadata, and/or descriptions of the underlying support conversation. In some example embodiments, this process may be performed by the conversation processing system(s) 130. However, in other example embodiments, this process may be performed by the support assessment system(s) 140.

At block 306, one or more prescribed process flows may be determined. In example embodiments, one or more categories (e.g., password reset, new purchase, pay bill, check account status, check eligibility for a reward, etc.) of support may be identified as corresponding to the support conversation based at least in part on the conversation parameter data 132. Based on these categories, corresponding prescribed process flows may be obtained, such as from the process datastore 154.

At block 308, one or more support assessment models(s) associated with the recorded support conversation may be identified. These models may be support assessment models 210 generated by the support assessment system(s) 140 or any other entity. At block 310, one or more support assessment outputs for the recorded support conversation may be determined based at least in part on the one or more conversation parameter data, the one or more prescribed process flows, and/or the one or more support assessment models. These support assessment outputs 160 may include, for example, the conversation quality score 162 and/or the process score 164. In example embodiments, the conversation quality score 162 may be determined by applying the conversation parameter data 132 of the support conversation to the conversation quality model 212. Similarly, the process score 164 may be determined by applying the conversation parameter data 132 and/or the prescribed process flow(s) of the support conversation to the process model 214.

At block 312, one or more outcomes associated with the recorded support conversation may be received. These outcomes 152 may be received from one or more other systems, such as the online gaming system(s) 150. The receipt of the outcomes 152 may, in example embodiments, lag the receipt of the conversation parameter data 132 and/or the prescribed process flow information. In some cases, the outcomes 152 may not be received all at one time, but rather may be received over time.

At block 314, additional support assessment outputs for the recorded support conversation may be determined based at least in part on the one or more outcomes, the conversation parameter data, and/or the one or more support assessment models. In example embodiments, the effectiveness score 166 may be determined by applying the conversation parameter data 132 of the support conversation and the outcomes 152 to the effectiveness model 216.

At block 316, the recorded support conversation may be annotated based at least in part on the conversation parameter data. Descriptive metadata corresponding to the support conversation may be generated based at least in part on the conversation parameter data 132. This metadata may be used to annotate the support conversation, such as by indicating locations within the support conversation where particular categories and/or topics are discussed, or by showing where one or more needs of the customer 102 have been resolved. This annotation may make it easier for someone to review the support conversation, if the need arises.

According to some embodiments, the operations of method 300 may be performed out of the order presented, with additional elements, and/or without some elements. Some of the operations of method 300 may further take place substantially concurrently and, therefore, may conclude in an order different from the order of operations shown above.

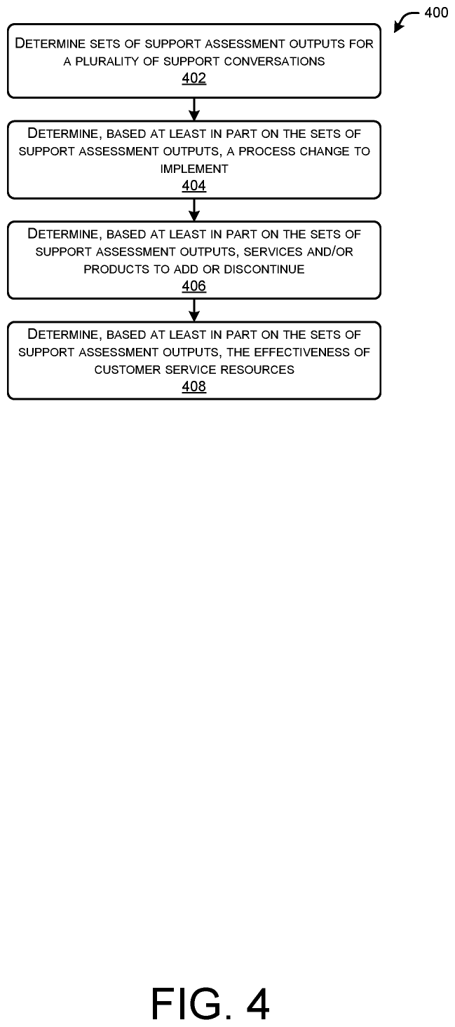

FIG. 4 illustrates a flow diagram of an example method 400 for determining process changes, changes to services or products, and/or the effectiveness of customer service resources, in accordance with example embodiments of the disclosure. In example embodiments, the method 400 may be performed by the support assessment system(s) 140. In some example embodiments, the method 400 may be performed in conjunction with one or more other entities of the environment 100, such as the conversation processing system(s) 130, the support platform system(s) 110, and/or the online gaming system(s) 140.

At block 402, sets of support assessment outputs for a plurality of support conversations may be determined. As discussed above in conjunction with FIG. 3, the support assessment outputs may be generated by applying one or more of the conversation parameter data 132, the outcomes 152, and/or prescribed process flows of the support conversation to one or more of the conversation quality model 212, process model 214, effectiveness model 216, and/or the overall score model 218.

At block 404, a process change to be implemented may be determined based at least in part on the sets of support assessment outputs. A process change to be recommended may be determined by comparing the effectiveness score to the process score. If a support conversation is relatively effective, as indicated by the effectiveness score, but did not adhere to the prescribed process flow, as indicated by the process score, then a process change may be recommended. Similarly, if a support conversation is relatively ineffective, as indicated the effectiveness score, but did adhere to the prescribed process flow, as indicated by the process score, then, again, a process change may be recommended. The difference between the process score and the effectiveness core may be compared to a threshold value to determine if a process change is to be recommended. In some cases, a determination of whether a process change is to be recommended may be based on a collection of support conversations, rather than a single support conversation. If there is a mismatch between process scores and effectiveness scores for a number of support conversations associated with a particular prescribed process flow, then that may prompt a recommendation for modifying the prescribed process flow.

At block 406, services and/or products to add or discontinue may be determined based at least in part on sets of support assessment outputs. If a particular product or service has a high level (e.g., total number or as a percentage) of support conversations or if support conversations of that product or service provides poor results, as measured by the support assessment scores 160, then a recommendation may be made to discontinue and/or modify that product or service.

At block 408, the effectiveness of customer service resources may be determined based at least in part on the sets of support assessment outputs. An aggregate of support conversations, and their corresponding support assessment scores, may be used to identify high performing customer support resources (e.g., human agents and/or automated agents) and poorly performing customer service resources. For example, the poorly performing customer support resources may be identified as having low average support assessment scores for the support conversations that they handle. In some cases, a low average assessment score (e.g., overall score, effectiveness score, process score, conversation quality score, etc.) may be identified by comparing the score to a corresponding threshold level. In other cases, the agents at or below a predetermined percentile threshold (e.g., lowest 5 percentile, lowest 10 percentile, etc.) of scores may be identified as poorly performing customer support resources. These customer support resources may be targeted for corrective actions, such as additional training for human agents or algorithmic changes to automated agents. High performing customer support resources may also be identified by similar mechanisms. The high performing resources may be rewarded, promoted, or engaged in training other customer service resources. Aggregated support assessment scores 160 of a particular agent 114, 118 may be used to make recommendations on the performance, rewards, and/or training needs of agents 114, 118.

According to some embodiments, the operations of method 400 may be performed out of the order presented, with additional elements, and/or without some elements. Some of the operations of method 400 may further take place substantially concurrently and, therefore, may conclude in an order different from the order of operations shown above.

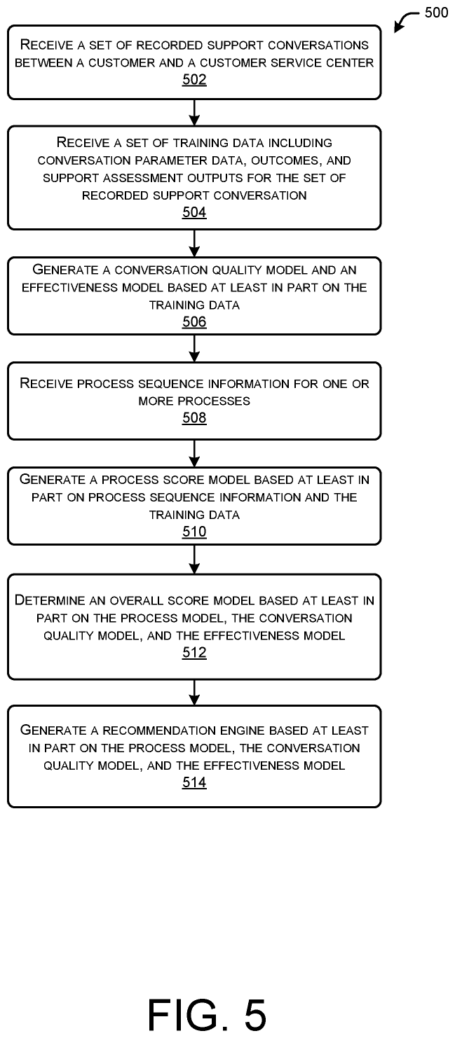

FIG. 5 illustrates a flow diagram of an example method to generate one or more support assessment models, in accordance with example embodiments of the disclosure. In example embodiments, the method 500 may be performed by the support assessment system(s) 140. In some example embodiments, the method 300 may be performed in conjunction with one or more other entities of the environment 100, such as the conversation processing system(s) 130, the support platform system(s) 110, and/or the online gaming system(s) 140.

At block 502, a set of recorded support conversations between a customer and customer service center may be received. In example embodiments, these support conversations may be received from the conversation datastore 120 or from any other suitable source that may supply training data to the support assessment system(s) 140.

At block 504, a set of training data, including conversation parameter data, outcomes, and support assessment outputs for the set of recorded support conversations, may be received. The training data may be generated by human or other models that generate support assessment outputs 160 associated with the recorded support conversations. The conversation parameter data 132 may result from a variety of analysis of the corresponding support conversation. This analysis may include ASR, NLU, clustering or the like. The conversation parameter data 132 may include, for example, k-means clustering data, n-grams, key phrases, parts-of-speech tagging, segmentation data, lexical semantics data, contextual semantics data, sentiment analysis data, discourse analysis data, combinations thereof, or the like. In the same or some alternative embodiments, the conversation parameter data 132 may include vector-based language understanding data. It should be understood that the aforementioned elements of the conversation parameter data are just examples, and that the conversation parameter data 132 may include any suitable analysis, fragmentation, metadata, and/or descriptions of the underlying support conversation.

At block 506, a conversation quality model and an effectiveness model may be generated based at least in part on the training data. The training data may then be used to train models that have the support conversations, the conversation parameter data, and/or the prescribed process flows as inputs, and the support assessment scores as outputs. This training may be supervised, unsupervised, or partially supervised (e.g., semi-supervised).

At block 508, process sequence information for one or more processes may be received. As discussed herein, this may be received from the process datastore 154. At block 510, a process model may be generated based at least in part on process sequence information and the training data. This may entail training the process score model to output the training processes scores in the training data for the corresponding training conversation parameter data and/or prescribed process flow. At block 512, an overall score model may be determined based at least in part on the process model, the effectiveness model, and/or the conversation quality model.

At block 514, a recommendation engine may be generated based at least in part on the process model, the effectiveness model, and/or the conversation quality model. This recommendation engine may incorporate a set of rules and/or checks of the support assessment scores to prompt one or more recommendations. These recommendations may include tagging poor agent performance, good agent performance, potential products or services to discontinue or modify, and/or potential changes to a prescribed process flow.

According to some embodiments, the operations of method 500 may be performed out of the order presented, with additional elements, and/or without some elements. Some of the operations of method 500 may further take place substantially concurrently and, therefore, may conclude in an order different from the order of operations shown above.

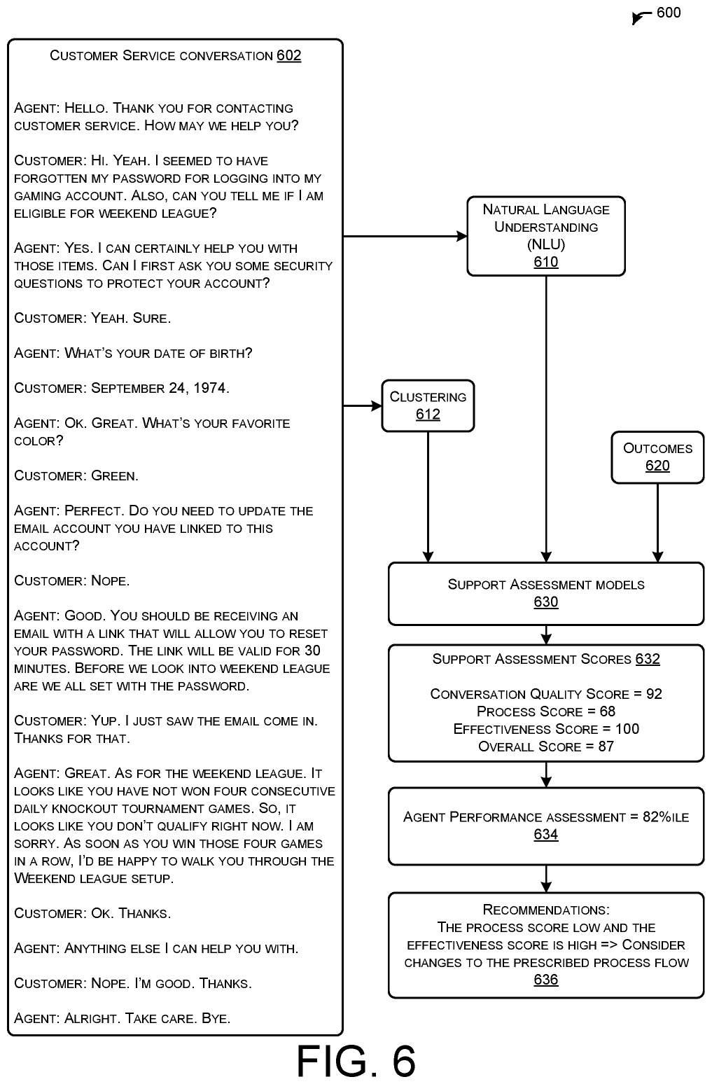

FIG. 6 illustrates a flow diagram of an example mechanism 600 for generating support assessment scores 632 and next steps 636 associated with a customer support conversation 602, in accordance with example embodiments of the disclosure. The customer support conversation 602, as shown here, is directed to a customer wishing to regain access to his or her user account and also to figure out if he or she is eligible to participate in a particular event. Thus, in this case, there may be two separate prescribed process flows for the agent to follow, namely password reset and weekend league process flows. The conversation may be provided to a NLU engine 610 and clustering engine 612 to generate conversation parameter data corresponding to the customer support conversation 602. Additionally, outcomes 620 may be received, such as from the online gaming system(s) 150. The outcomes 620 may indicate, for example, if the customer finished the process of resetting his or her password.

The conversation parameter data, as well as the outcomes 620 may be applied to the support assessment models 630 to generate support assessment scores 632. As shown, the effectiveness score and the conversation quality score may be relatively high, and the process score is relatively lower. The overall score may be an average of the conversation quality score, process score, and the effectiveness score. The overall score may be used to measure the performance of the agent 634. In this case, the agent's score is shown to be at the 82% ile. Additionally, the inconsistency between the process score and the effectiveness score may prompt a recommendation 636 to consider changes to the prescribed process flow.

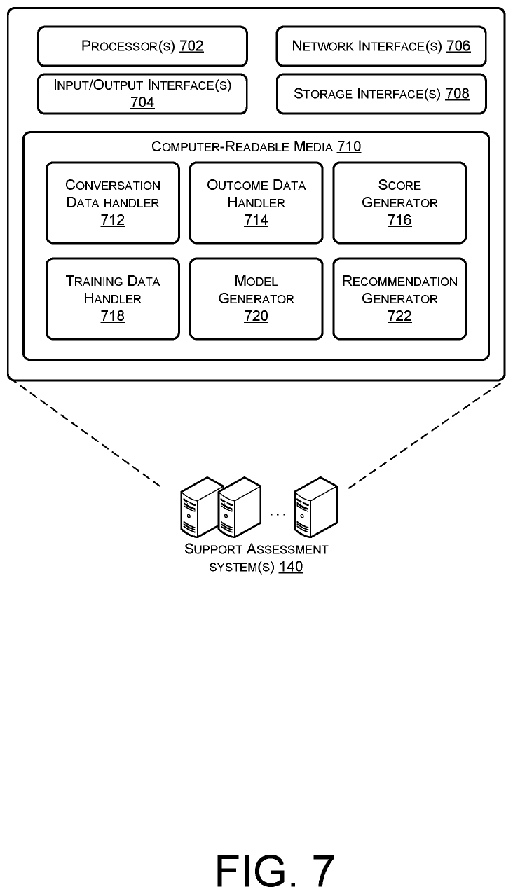

FIG. 7 illustrates a block diagram of example support assessment system(s) 700 that may provide predictive model generation services, in accordance with example embodiments of the disclosure. The support assessment system(s) 700 may include one or more processor(s) 702, one or more input/output (I/O) interface(s) 704, one or more network interface(s) 706, one or more storage interface(s) 708, and computer-readable media 710.

In some implementations, the processors(s) 702 may include a central processing unit (CPU), a graphics processing unit (GPU), both CPU and GPU, a microprocessor, a digital signal processor or other processing units or components known in the art. Alternatively, or in addition, the functionality described herein may be performed, at least in part, by one or more hardware logic components. For example, and without limitation, illustrative types of hardware logic components that may be used include field-programmable gate arrays (FPGAs), application-specific integrated circuits (ASIC s), application-specific standard products (ASSPs), system-on-a-chip systems (SOCs), complex programmable logic devices (CPLDs), etc. Additionally, each of the processor(s) 702 may possess its own local memory, which also may store programs, program data, and/or one or more operating systems. The one or more processor(s) 702 may include one or more cores.

The one or more input/output (I/O) interface(s) 704 may enable the support assessment system(s) 700 to detect interaction with a user (e.g., a customer service center supervisor) and/or other computing system(s). The I/O interface(s) 704 may include a combination of hardware, software, and/or firmware and may include software drivers for enabling the operation of any variety of I/O device(s) integrated on the support assessment system(s) 700 or with which the support assessment system(s) 700 interacts, such as displays, microphones, speakers, cameras, switches, and any other variety of sensors, or the like. In example embodiments, the I/O devices of the support assessment system(s) 700 may include audio, video, and/or other input functionality.

The network interface(s) 706 may enable the support assessment system(s) 700 to communicate via the one or more network(s). The network interface(s) 706 may include a combination of hardware, software, and/or firmware and may include software drivers for enabling any variety of protocol-based communications, and any variety of wireline and/or wireless ports/antennas. For example, the network interface(s) 706 may comprise one or more of a cellular radio, a wireless (e.g., IEEE 802.1x-based) interface, a Bluetooth® interface, and the like. In some embodiments, the network interface(s) 706 may interfaces to the Internet. The network interface(s) 706 may further enable the support assessment system(s) 700 to communicate over circuit-switch domains and/or packet-switch domains.

The storage interface(s) 708 may enable the processor(s) 702 to interface and exchange data with the computer-readable medium 710, as well as any storage device(s) external to the support assessment system(s) 700. The storage interface(s) 708 may further enable access to removable media.

The computer-readable media 710 may include volatile and/or nonvolatile memory, removable and non-removable media implemented in any method or technology for storage of information, such as computer-readable instructions, data structures, program functions, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 710 may be implemented as computer-readable storage media (CRSM), which may be any available physical media accessible by the processor(s) 702 to execute instructions stored on the memory 710. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 1002. The computer-readable media 710 may have an operating system (OS) and/or a variety of suitable applications stored thereon. The OS, when executed by the processor(s) 1002 may enable management of hardware and/or software resources of the support assessment system(s) 700.

Several functional blocks having instruction, data stores, and so forth may be stored within the computer-readable media 710 and configured to execute on the processor(s) 702. The computer readable media 710 may have stored thereon a conversation data handler 712, an outcome data handler 714, a score generator 716, a training data handler 718, model generator 720, and a recommendation generator 722. It will be appreciated that each of the blocks 712, 714, 716, 718, 720, 722, may have instructions stored thereon that when executed by the processor(s) 702 may enable various functions pertaining to the operations of the support assessment system(s) 700.

The instructions stored in the conversation data handler 712, when executed by the processor(s) 702, may configure the support assessment system(s) 700 to receive and store conversation parameter data associated with one or more support conversations. This data may be staged prior to applying the data to the support assessment models. The processor(s) 702 may further apply the conversation parameter data to the support assessment models. In some example embodiments, the support assessment system(s) 700 themselves may be configured to determine the conversation parameter data for the support conversations.

The instructions stored in the outcome data handler 714, when executed by the processor(s) 702, may configure the support assessment system(s) 700 to receive outcomes data from one or more sources. These outcomes may be matched to their corresponding support conversations, such as by matching to corresponding customers. These outcomes may be applied to one or more support assessment models, such as an effectiveness model to determine an effectiveness score.

The instructions stored in the score generator 716, when executed by the processor(s) 702, may configure the support assessment system(s) 700 to apply the outcomes and the conversation parameter data to the support assessment models to generate support assessment scores for a support conversation. These support assessment scores may include a conversation quality score, a process score, and effectiveness score, and/or an overall score.

The instructions stored in the training data handler 718, when executed by the processor(s) 702, may configure the support assessment system(s) 700 to receive training data and store the data for the process of training the support assessment models.

The instructions stored in the model generator 720, when executed by the processor(s) 702, may configure the support assessment system(s) 700 to train the support assessment models as described herein. The training data may be used to fit the training support assessment outcomes to the training inputs of the models, such as the conversation parameter data and/or outputs.

The instructions stored in the recommendation generator 722, when executed by the processor(s) 702, may configure the support assessment system(s) 700 to provide one or more recommendations, as described herein. These recommendations may be generated based on one or more rules and/or checks performed on support assessment scores for a support conversation or an aggregate of support conversations.

The illustrated aspects of the claimed subject matter may also be practiced in distributed computing environments where certain tasks are performed by remote processing devices that are linked through a communications network. In a distributed computing environment, program functions can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus implement one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A support assessment system, comprising:
one or more processors; and
one or more computer-readable media storing computer-executable instructions that, when executed by the one or more processors, cause the one or more processors to:
receive conversation parameter data associated with a support conversation with a user;
determine, based at least in part on the conversation parameter data and a conversation quality model, a conversation quality score associated with the support conversation;
receive an outcome associated with the user;
determine, based at least in part on the outcome and an effectiveness model, an effectiveness score associated with the support conversation; and
determine, based at least in part on the conversation quality score and the effectiveness score, an aggregate score associated with the support conversation.

2. The support assessment system of claim 1, wherein the computer-executable instructions further cause the one or more processors to:
determine a category associated with the support conversation based at least in part on the conversation parameter data;
identify, based at least in part on the category, a prescribed process flow associated with the support conversation; and
determine, based at least in part on the prescribed process flow and a process model, a process score associated with the support conversation, wherein the aggregate score is based at least in part on the process score.

3. The support assessment system of claim 2, wherein the computer-executable instructions further cause the one or more processors to:
compare the process score to the effectiveness score; and
generate a process recommendation based at least in part on the comparison.

4. The support assessment system of claim 1, wherein the computer-executable instructions further cause the one or more processors to:
generate, one or more metadata descriptive of the support conversation based at least in part on the conversation parameter data; and
annotate the support conversation with the one or more metadata.

5. The support assessment system of claim 1, wherein the conversation quality model comprises at least one of: (i) a neural network model; (ii) a logistic regression algorithm; (iii) a decision tree model; (iv) a random forest model; or (v) a Bayesian network model.

6. The support assessment system of claim 1, wherein the computer-executable instructions further cause the one or more processors to:
receive training data corresponding to a plurality of training support conversations, the training data including training conversation parameter data and training quality scores corresponding to individual ones of the plurality of training support conversations; and
generate the conversation quality model based at least in part on the training data.

7. The support assessment system of claim 6, wherein the training data further includes outcomes corresponding to individual ones of the plurality of training support conversations, wherein the computer-executable instructions further cause the one or more processors to generate the effectiveness model.

8. The support assessment system of claim 1, wherein the conversation quality score is a first conversation quality score and the support conversation is a first support conversation, and wherein the computer-executable instructions further cause the one or more processors to:
determine a second conversation quality score corresponding to a second support conversation;
determine that the first conversation quality score corresponds to a first support resource;
determine that the second conversation quality score corresponds to a second support resource; and
determine, based at least in part on the first conversation quality score and the second conversation quality score, that the first support resource outperforms the second support resource.

9. A support assessment method, comprising:
receiving a first set of conversation parameter data associated with a first support conversation with a first user;
receiving a second set of conversation parameter data associated with a second support conversation with a second user;
determining, based at least in part on the first set of conversation parameter data and a conversation quality model, a first conversation quality score associated with the first support conversation;
determining, based at least in part on the second set of conversation parameter data and the conversation quality model, a second conversation quality score associated with the second support conversation;
identifying a first prescribed process flow associated with the first support conversation;
determining that the second support conversation is associated with the second support conversation;
determining, based at least in part on the first prescribed process flow, the first set of conversation parameter data, and a process model, a first process score associated with the first support conversation;
determining, based at least in part on the first prescribed process flow, the second set of conversation parameter data, and the process model, a second process score associated with the second support conversation; and
determining, based at least in part on the first conversation quality score, the second conversation quality score, the first process score, and the second process score, that the first prescribed process flow is to be altered.

10. The support assessment method of claim 9, further comprising:
receiving a first outcome associated with the first support conversation;
receiving a second outcome associated with the second support conversation;
determining, based at least in part on the first outcome and an effectiveness model, a first effectiveness score associated with the first support conversation; and
determining, based at least in part on the second outcome and the effectiveness model, a second effectiveness score associated with the second support conversation, wherein determining that the first prescribed process flow is to be altered is further based at least in part on the first effectiveness score and the second effectiveness score.

11. The support assessment method of claim 10, further comprising:
determining a first overall score based at least in part on the first conversation quality score, the first process score, and the first effectiveness score; and
determining a second overall score based at least in part on the second conversation quality score, the second process score, and the second effectiveness score.

12. The support assessment method of claim 11, further comprising:
determining a product or service associated with the first support conversation and the second support conversation; and
recommend, based at least in part on the first overall score and second overall score, that the product or service be discontinued.

13. The support assessment method of claim 9, wherein the process model comprises at least one of: (i) a neural network model; (ii) a logistic regression algorithm; (iii) a decision tree model; (iv) a random forest model; or (v) a Bayesian network model.

14. The support assessment method of claim 9, wherein the first set of conversation parameter data comprises at least one of Natural Language Understanding (NLU) data, clustering data, or Automated Speech Recognition (ASR) data.

15. The support assessment method of claim 9, further comprising:
receiving training data corresponding to a plurality of training support conversations, the training data including training conversation parameter data, outcomes, and training conversation quality scores corresponding to individual ones of the plurality of training support conversations; and
generating a conversation quality model based at least in part on the training data.

16. A system, comprising:
one or more processors; and
one or more computer-readable media storing computer-executable instructions that, when executed by the one or more processors, cause the one or more processors to:
receive a first set of training data corresponding to a first training support conversation, the first set of training data including a first training conversation parameter data, a first outcome, a first prescribed process flow corresponding to the first training support conversation, a first training conversation quality score, a first training process score, and a first training effectiveness score corresponding;
receive a second set of training data corresponding to a second training support conversation, the second set of training data including a second training conversation parameter data, a second outcome, a second prescribed process flow corresponding to the second training support conversation, a second training conversation quality score, a second training process score, and a second training effectiveness score corresponding;
generate a conversation quality model based at least in part on the first set of training data and the second set of training data;
generate a process model based at least in part on the first set of training data and the second set of training data;
generate an effectiveness model based at least in part on the first set of training data and the second set of training data;
receive conversation parameter data corresponding to a support conversation;
receive outcome data corresponding to the support conversation;
identify a prescribed process flow corresponding to the support conversation;
determine, based at least in part on the conversation quality model and the conversation parameter data, a conversation quality score associated with the support conversation;
determine, based at least in part on the effectiveness model and the outcome data, an effectiveness score associated with the support conversation; and
determine, based at least in part on the prescribed process flow and the process model, a process score associated with the support conversation.

17. The system of claim 16, wherein the effectiveness model comprises at least one of: (i) a neural network model; (ii) a logistic regression algorithm; (iii) a decision tree model; (iv) a random forest model; or (v) a Bayesian network model.

18. The system of claim 16, wherein the computer-executable instructions further cause the one or more processors to:
generate, one or more metadata descriptive of the support conversation based at least in part on the conversation parameter data; and
annotate the support conversation with the one or more metadata.

19. The system of claim 16, wherein the conversation parameter data comprises at least one of Natural Language Understanding (NLU) data, clustering data, or Automated Speech Recognition (ASR) data.

20. The system of claim 16, wherein the computer-executable instructions further cause the one or more processors to:
determine that the effectiveness score is greater than a first threshold;
determine that the process score is below a second threshold; and
determine that the prescribed process flow is to be altered.
